(19) United States
(12) Patent Application Publication
(10) Pub. No.: US 2009/0022949 A1
(43) Pub. Date: Jan. 22, 2009

(54) Functional-Element-Mounted Module, Process for Producing the Same, Resin Sealing Plate for Use Therein, and Substrate Structure for Resin Sealing

(75) Inventors: Yoshihito Horita, Ishikawa-ken (JP); Shiyuki Kanisawa, Tochigi-ken (JP); Takahiro Asada, Ishikawa-ken (JP); Yoshihiro Yoneda, Ishikawa-ken (JP)

Correspondence Address: KANESAKA BERNER AND PARTNERS LLP, 1700 DIAGONAL RD, SUITE 310, ALEXANDRIA, VA, 22314-2848, US

(73) Assignee: SONY CHEMICAL & INFORMATION DEVICE CORPORATION, Tokyo (JP)

(21) Appl. No.: 12/086,152

(22) PCT Filed: Nov. 28, 2006
(86) PCT No.: PCT/JP2006/323658

§ 371 Date: Jul. 11, 2008

(30) Foreign Application Priority Data
Mar. 3, 2006 (JP) 2006-057876

(51) Int. Cl. B32B 3/10; B05D 5/06; C08F 2/48; B31B 1/60

(52) U.S. Cl. 428/138; 427/162; 427/508; 156/60; 428/131

(57) ABSTRACT

Opposed to a substrate (2) having a functional element (1) with a functional portion (1a) mounted thereon, there is disposed a resin sealing plate (3) provided with an opening (3a) corresponding to the functional portion (1a) of the functional element (1) with a given spacing therebetween. Impregnation and filling of a sealing resin (5) in the spacing between the substrate (2) and the resin sealing plate (3) are carried out by the use of the capillary phenomenon. Thus, resin sealing of the functional element (1) can be realized without damaging to the function of the functional portion (1a).

### TECHNICAL FIELD

The present invention relates to a functional-element-mounted module having a functional element, such as an optical functional element, mounted on a substrate and sealed with a resin and to a process for producing the same, and particularly to a novel functional-element-mounted module having the sealing resin impregnated and filled therein utilizing the capillary phenomenon and to a process for producing the same. The present invention relates also to a resin sealing plate and a substrate structure for resin sealing, both used in performing the producing processes.

### BACKGROUND ART

The optical functional element that is a typical one of the functional elements has widely been used for an optical pickup built in a drive unit for optical discs, such as CDs, MDs, DVDs, etc. When a light-receiving device or light-emitting device is used as the functional element, a functional portion, such a light-receiving portion, light-emitting portion, etc. has to be mounted on the substrate without being blocked off by the substrate. For example, the procedure that has been taken in a practical manner comprises mounting the light-receiving portion or light-emitting portion on an interconnection substrate, with the portion upside down, and sealing the portion in a transparent package.

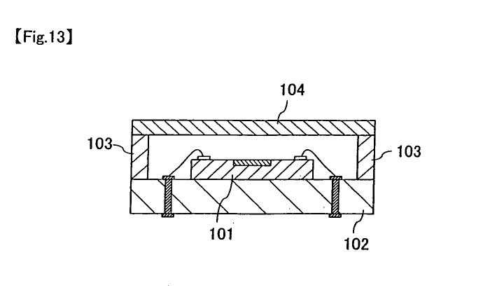

FIG. 13 shows one example of a functional-element-mounted module having an optical functional element sealed in a package having a hollow structure. An optical functional element 101 is mounted on an interconnection substrate 102, with a functional portion thereof directed upward, and a transmissive member 104 is attached via a frame-shaped spacer 103 to the interconnection substrate so as to cover the optical functional element. When the optical functional element 101 is a light-receiving device or light-emitting device, for example, it is necessary to receive or emit light via the transmissive member 104 and to form the transmissive member 104 of a material having high optical transparency (glass, for example).

Otherwise, a structure, in which the optical functional element is facedown-bonded onto the glass substrate and a cover member is attached so as to cover the mounted optical functional element, has been proposed by the present inventors (refer, for example, to Patent Document 1). In the optical functional element-mounted module disclosed in Patent Document 1, the optical functional element is facedown bonded onto the glass substrate and, at the same time, the cover member is attached so as to cover the mounted optical functional element. The interspace between the optical functional element and the glass substrate is left open without being filled with an underfill material to form a hollow structure.

Patent Document 1: JP-A 2000-79457

### DISCLOSURE OF THE INVENTION

### Problems the Invention Intends to Solve

When adopting the structure in which the functional element is sealed in the package having the hollow structure as shown in FIG. 13, the module is apt to have an increased height as a whole, thereby failing to materialize a compact module. In addition, when considering the production thereof, the assembling procedure will become cumbersome and, furthermore, an infallibly sealed structure is difficult to form. Thus, the reliability thereof will possibly be lost. In the case of insufficient sealing, for example, invasion of air into the package will possibly deteriorate the electrodes of the functional element to possibly induce the reduction of the characteristics thereof with long-term use. Moreover, since the transmissive member 104 is required to have high optical transparency, it is necessary to use an expensive material, such as glass. From the standpoint of protection of the sealed functional element 101, the expensive material is required to have high strength and large thickness to some extent. In this case, however, the problem of reducing the optical transparency will possibly be posed.

Also in the optical functional element-mounted module described in Patent Document 1, since it is necessary to protect the optical functional element with a cover member, the same problem as mentioned above is posed. In particular, since the substrate is to be formed of glass, an increase in cost cannot be avoided. In addition, since a special technique called facedown bonding has to be adopted to pose the problems of necessitating various alterations in the mounting procedure in comparison with the ordinary mounting and wiring by wire bonding.

The present invention has been proposed in view of the problems the prior art has posed, and an object thereof is to provide a functional-element-mounted module and a process for producing the same, each of which can readily realizes the formation of a sealed structure having a functional element or electrodes sealed with resin, eliminate coating by the sealing resin as regards a functional portion of the functional element without making any special operation and sufficiently securing optical transparency. Another object of the present invention is to provide a functional-element-mounted module and a process for producing the same, each of which can realize the formation of a small-sized functional-element-mounted module, reduce the production cost and maintain the reliability of the functional element for a long period of time. Still another object of the present invention is to provide a resin sealing plate and a substrate structure for resin sealing, both used in the producing processes.

### Means for Solving the Problems

To attain the above objects, the present invention provides a functional-element-mounted module comprising a substrate, a functional element provided with a functional portion and mounted on the substrate, a resin sealing plate formed therein with an opening corresponding in position to the functional portion of the functional element and disposed as opposed to the substrate at a distance of 200 μm to 1000 μm and a sealing resin impregnated and filled between the substrate and the resin sealing plate and formed therein with an opening corresponding in position to the opening of the resin sealing plate, wherein the functional portion of the functional element faces the opening of the sealing resin. The present invention further provides a process for producing a functional-element-mounted module, comprising the steps of disposing a substrate having mounted thereon a functional element having a mounting portion and a resin sealing plate formed therein with an opening corresponding in position to the functional portion of the functional element as opposed to each other at a prescribed distance, and impregnating and filling a sealing resin between the substrate and the resin sealing plate utilizing a capillary phenomenon.

The substrate having the functional element mounted thereon and the resin sealing plate are disposed as opposed to each other at an appropriate interval (1000 μm or less, for example), and a sealing resin is supplied to the spacing between the two. As a result, the sealing resin is drawn by means of the capillary phenomenon between the substrate and the resin sealing plate and impregnated and filled therebetween. Since the resin sealing plate is provided with the opening corresponding in position to the functional portion of the functional element, the sealing resin impregnated and filled between the substrate and the resin sealing plate is prevented from entering the opening by the action of the surface tension at the edge of the opening. As a consequence, the functional portion of the functional element is prevented from being covered by the sealing resin to sufficiently secure the optical transparency, for example.

In the present invention, no special operation is required for impregnating and filling the sealing resin and for preventing the sealing resin from entering the opening. The formation of the opening in the resin sealing plate enables spontaneous impregnation and filling of the sealing resin owing to the capillary phenomenon and the surface tension of the sealing resin.

When performing the impregnation and filling of the sealing resin, it is effective to provide frames on the opposite sides of the functional portion for controlling the flow of the sealing resin and to supply a liquid sealing resin from one of the opposite open ends of the opening defined by the frames. The frames thus disposed enable the flow direction of the sealing resin to be regulated in one direction and the impregnation and filling of the sealing resin to be made smooth.

In addition, when the flow direction of the sealing resin has thus been regulated in one direction by means of the disposition of the frames, the open end opposed to the open end from which the sealing resin is supplied may be provided with a resin flow control mechanism functioning to narrow the flow path for the sealing resin. When flowing the sealing resin in one direction, the amount of the sealing resin circulating around the downstream position of the opening may possibly be insufficient. The provision of the resin flowing control mechanism facilitates the circulation of the sealing resin toward around the rear side of the opening.

What is conceivable as the sealing resin filling method comprises the steps of forming a frame around the functional element, for example, for stemming the flow of the sealing resin, using a dispenser, for example, to drop the sealing resin into the frame and placing thereon the resin sealing plate provided with the opening. In this case, however, it is required to precisely control the amount of the sealing resin to be dropped and to use a highly precise dispenser. When the amount of the sealing resin to be dropped is high even if only slightly, for example, there is a possibility of the excess amount of the sealing resin entering inside the opening (i.e. on the functional portion of the functional element) when depressing the sealing resin using the resin sealing plate. In addition, after dropping the sealing resin, it is required to rapidly place the resin sealing plate, with the opening aligned with the functional portion. This will cause an increase in number of man-hour and make the operation cumbersome.

On the other hand, in the production process according to the present invention, since the sealing resin is impregnated and filled, the circulation of the sealing resin is spontaneously stopped as soon as the spacing between the substrate and resin sealing plate is packed with the sealing resin without excessively supplying the sealing resin. Therefore, no precision is required with respect to the supply of the sealing resin, and use of a highly precise dispenser is not required. In addition, other steps to be taken after the supply of the sealing resin (the step of placing the resin sealing plate, for example) are not required, and there is no need to place the resin sealing plate in a hurry after dropping the sealing resin and before hardening the same. Thus, the reduction in number of man-hour and simplification of the process can be attained.

In the meantime, the resin sealing plate of the present invention is that used in the process for producing the functional element-mounted module and provided with an opening corresponding in position to the functional portion of the functional element and with a resin flow control opening for controlling the flow of the resin utilizing the surface tension. The use of the resin sealing plate in the production process for the functional element-mounted module can suppress entrance of the sealing resin onto the functional portion of the functional element and can perform resin sealing over the entire periphery of the functional element.

In addition, the substrate structure for resin sealing according to the present invention comprises a substrate having mounted thereon a functional element having a functional portion and a resin sealing plate provided therein with an opening corresponding in position to the functional portion of the functional element and disposed as opposed to the substrate at a predetermined interval, wherein projecting frames are formed at opposite side positions of the functional element and on the substrate and wherein the resin sealing plate is supported on the frames and disposed as opposed to the substrate at the predetermined interval as described above.

Also, the substrate structure for resin sealing is that applied to the producing process for the functional element-mounted module and, since the frames are formed at opposite side positions of the functional element, the flow of the sealing resin is regulated in one direction to realize smooth impregnation and filling of the sealing resin. In addition thereto, since the resin sealing plate is supported at the backside thereof on the frames, the resin sealing plate is secured in rigidity, is easy to handle and realizes the state in which the opening of the resin sealing plate is aligned with the functional portion of the functional element with high precision.

### Effects of the Invention

According to the present invention, it is made possible to perform highly reliable resin sealing without covering the functional portion of the functional element with the resin and efficiently produce the functional element-mounted module using inexpensive equipment without requiring use of any special operation for the resin sealing and requiring use of a highly precise dispenser. In the functional element-mounted module to be produced, since no package for resin sealing is used, it is made possible to reduce the height of the entire module to realize the miniaturization of the module. In addition, since the functional element and electrodes are sealed with the resin to eliminate contact thereof with the air, it is made possible to secure the reliability over a long period of time. Furthermore, since there is no need to use a package or substrate made of glass, it is made possible to reduce the production cost to a great extent.

### BEST MODE FOR CARRYING OUT THE INVENTION

The functional element-mounted module and the producing process thereof according to the present invention will be described hereinafter in detail with reference to the accompanying drawings. The resin sealing plate and substrate structure for resin sealing will be described in addition to the description of the producing process.

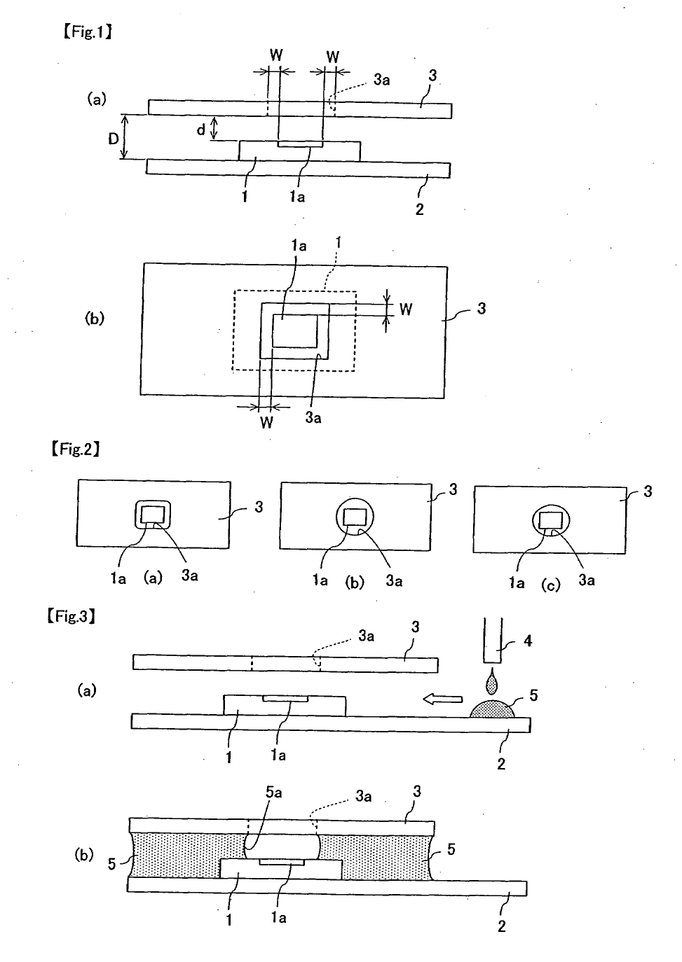

First, the fundamental configuration of the process for producing the functional element-mounted module according to the present invention will be described. The fundamental idea of the producing process according to the present invention lies in impregnating and filling a liquid sealing resin between the substrate and the resin sealing plate utilizing the capillary phenomenon and, in the implementation thereof, a resin sealing plate 3 is disposed above and as opposed to a substrate 2 having a functional element 1 mounted thereon at a predetermined interval as shown in FIG. 1(a).

As the functional element 1 mounted on the substrate 1, any functional element can be used insofar as a functional portion 1a thereof can avoid being coated with the sealing resin. To be specific, optical functional elements can be cited, and light-receiving devices and light-transmitting devices can be exemplified. In addition, the structure of connection of the functional element 1 to the substrate 2 can optionally be adopted. For example, it may be adopted that the electrode formed on the substrate and the terminal electrode of the functional element are electrically connected via a wire bonding or a bump connection, for example. The functional element 1 is mounted on the substrate, with the functional portion 1a directed upward in the drawing.

The substrate 2 is formed with a wire for incorporating the functional element 1 into part of the circuit and, as the substrate, a so-called printed-wiring assembly is usable. In this case, though the material for the substrate 2 is arbitrary, it preferably has some rigidity. For example, a glass epoxy substrate or ceramic substrate can be used. In consideration of the production cost and ready cutting in the dicing treatment, the glass epoxy substrate can advantageously be used.

Though the material for the resin sealing plate 3 is also arbitrary, since it has to be cut in the dicing treatment to form a functional element-mounted module, it is made of a material somewhat easy to cut. From this point of view, various plastic plates and glass epoxy substrates having no wire can be used. Since the glass epoxy substrate is inexpensive, it is useful from the standpoint of reducing the production cost.

When disposing the substrate 2 and the resin sealing plate 3 as opposed to each other, a distance D is preferably set to be appropriate. When the distance D is too large, the sealing resin fails to form a meniscus to possibly make it difficult to fill the sealing resin utilizing the capillary phenomenon. Therefore, the distance D between the substrate 2 and the resin sealing plate 3 is preferably 1000 μm or less. Though the lower limit of the distance is not particularly prescribed, when the distance D is too small, the upper surface of the functional element 1 possibly comes into contact with the resin sealing plate 3. This is undesirable from the standpoint of sealing the functional element 1 with a resin. Therefore, the distance is preferably in the range of 200 μm to 1000 μm and furthermore a distance d between the upper surface of the functional element 1 and the lower surface of the resin sealing plate 3 is preferably set to be appropriate in accordance with the thickness of the functional element 1.

Here, the distance d between the upper surface of the functional element 1 and the lower surface of the resin sealing plate 3 has no problem insofar as the upper surface of the functional element 1 and the lower surface of the resin sealing plate 3 are not brought into contact with each other (i.e. d=0 is not satisfied). In view of smooth impregnation and filling of the sealing resin to be attained, however, it is preferred to set the distance to be appropriate. To be specific, the distance d around the functional portion 1a of the functional element 1 is preferably in the range of 100 μm to 600 μm.

The resin sealing plate 3 is required as shown in FIG. 1(b) to have an opening 3a corresponding in position to the functional portion 1a of the functional element 1. The formation of the opening 3a in the resin sealing plate 3 enables the capillary phenomenon to be utilized to prevent the sealing resin from invading into the opening 3a (onto the functional portion 1a). Therefore, the size of the opening 3a is preferably set to be slightly larger than that of the functional portion 1a of the functional element 1. A distance w from the end of the opening 3a to the functional portion 1a when seen from a plane projection view is preferably in the range of 100 μm to 800 μm, more preferably in the range of 500 μm to 700 μm.

The shape of the opening 3a may be designed in compliance with the shape of the functional portion 1a of the functional element. Though the opening 3a is made rectangular here, it is made possible to chamfer the corners of the rectangular shape to have arcuate shapes as shown in FIG. 2(a). In addition, it is made possible to form the opening 3a in a circular or elliptical shape as shown in FIG. 2(b) or 2(c). When the opening 3a has corners, the surface tension fails to function uniformly in the vicinity of the opening 3a in the impregnation and filling of the sealing resin described later, resulting in a possible hindrance to the function of the opening 3a. This hindrance can be eliminated through the formation of the arcuate shapes at the corners of the opening or the formation of a circular or elliptical opening as described above.

Next, as shown in FIG. 3(a), a dispenser 4 is used to drop a liquid sealing resin 5 onto the neighborhood of the open side of the substrate 2 disposed as opposed to the resin sealing plate 3. In general, the sealing resin 5 is dropped onto an extension of the substrate 2. The precision of the amount of the sealing resin to be dropped is not required. The amount is sufficient if the spacing between the substrate 2 and the resin sealing plate is packed with the sealing resin. Therefore, an inexpensive dispenser low in application precision can be used, when applying the sealing resin 5, without use of a highly precise dispenser.

Though an arbitrary material can be used as the sealing resin 5, it is made possible to advantageously use thermosetting resins or ultraviolet-curable resins. An epoxy resin that is one of the thermosetting resins is a material preferred from the standpoint of securing the application precision.

The sealing resin 5 is required to be liquid at the time it is dropped onto the substrate 2. Use of the liquid sealing resin 5 to be supplied enables the impregnation and filling thereof utilizing the capillary phenomenon. At this time, when the sealing resin 5 has viscosity high enough than being conceivable, there is a possibility of the impregnation and filling thereof failing to be performed smoothly. Therefore, the viscosity of the sealing resin 5 is preferably 10 Pa·s or less. Incidentally, the viscosity of the sealing resin 5 is that on the substrate 2 and, when the substrate 2 is heated, for example, it is also made possible to set the viscosity to be the same as that in consequence of the heating.

When part of the liquid sealing resin 5 dropped onto the substrate 2 comes into contact with the end of the resin sealing plate 3, the sealing resin 5 is attracted toward the spacing between the substrate 2 and the resin sealing plate 3 by means of the capillary phenomenon to perform the impregnation and filling of the sealing resin. In the impregnation and filling, a necessary and sufficient amount of the sealing resin 5 is filled in the spacing between the substrate 2 and the resin sealing plate 3 without performing any operation to seal the functional element 1 with the resin. Here, the sealing resin 5 being impregnated by means of the capillary phenomenon is blocked at the opening 3a in the resin sealing plate 3 to prevent the sealing resin from entering the opening 3a. Since a meniscus is formed on the sealing resin 5 by means of the surface tension when the liquid sealing resin has reached the open end of the opening 3a, there is no case where the sealing resin enters the opening 3a.

Heating after the impregnation and filling cures the sealing resin 5. The heating time may be set, depending on the kind of the sealing resin 5 to be used, to be sufficient for curing the sealing resin 5. The sealing resin 5 that has been cured can fix the resin sealing plate 3 and serve to protect the functional element 1. After curing the sealing resin 5, the individual functional elements 1 are cut off into chips to produce functional element-mounted modules.

FIG. 3(b) shows the state of the sealing resin 5 filled by the aforementioned impregnation and filling. The spacing is packed with the sealing resin 5, and the functional element 1 is kept in a state of being well sealed with the resin. On the other hand, the upper surface of the functional portion 1a of the functional element 1 faces, as exposed to, an opening 5a formed on the sealing resin 5 correspondingly in position to the opening 3a of the resin sealing plate 3 without being covered by the sealing resin 5.

When an ultraviolet curing resin is used as the sealing resin 5, for example, the impregnation and filling thereof can be performed using the irradiation with ultraviolet rays together. In this case, however, it is preferred that the neighborhood of the opening 3a formed in the resin sealing plate 3 is only irradiated with ultraviolet rays. This enables the sealing resin 5 being impregnated to be cured in the vicinity of the opening 3a, thereby enabling the sealing resin 5 to be infallibly prevented from entering the opening 3a in cooperation with the surface tension. If the ultraviolet rays should spread to irradiate the whole of the resin sealing plate 3, for example, there is a fair possibility of the sealing resin being impregnated and filled being unintentionally cured. In order to avoid this, keen attention is to be paid to the spreading of the ultraviolet rays.

The irradiation with the ultraviolet rays may properly be performed from before the sealing resin 5 is being impregnated or during the course of the impregnation of the sealing resin 5 and is not required to completely cure the sealing resin 5. Complete curing is performed by heating after the impregnation and filling of the sealing resin 5.

As a consequence, the functional element 1 is sealed with the resin and, at the same time, a functional element-mounted module with the functional portion 1a not covered by the sealing resin can be produced. In the functional element-mounted module, when the functional element 1 is an optical functional element, a short-wavelength laser, such as a bluish-purple laser beam, can also be input and output without being attenuated. In addition, there is no need to protect the functional element 1 using a package and to use specially coated, expensive glass that is required when using the package.

The embodiment described above corresponds to the fundamental configuration of the present invention. When actually producing a functional element-mounted module, however, various modifications may be adopted to realize efficient impregnation and filling. When plural functional elements 1 are sealed in a lump with a resin, for example, the functional elements are disposed in a matrix form on the substrate and a resin sealing plate having a large area is formed with openings disposed in a matrix form, thereby performing impregnation and filling. In this case, however, since the flow of the sealing resin 5 being impregnated is not regulated, there is a possibility of uniform filling being difficult to perform. In such cases as this, it is effective that the opposite sides of each functional element 1 are provided with frames to regulate the flow of the sealing resin in one direction.

An embodiment in which the frames are utilized to control the flow of the sealing resin will be described hereinafter. FIGS. 5(a) and 5(b) show examples of projecting frames 6 of a prescribed height disposed on the opposite sides of the functional element 1. This embodiment is identical with the preceding embodiment except that the frames 6 are disposed on the opposite sides of the functional element 1.

The disposition of the frames 6 on the opposite sides of the functional element 1 fulfills the function to regulate the flow of the sealing resin 5 in one direction [the direction shown by an arrow in FIG. 5(b)]. As a result, even in the case where plural functional elements 1 are disposed on the substrate and where the functional elements are sealed in a lump with the resin through impregnation and filling utilizing the capillary phenomenon, the flow of the resin to every one functional element is made stable and, therefore, smooth and infallible impregnation and filling of the sealing resin 5 can be performed.

The frames 6 serve also as spacers for setting the spacing between the substrate 2 and the resin sealing plate 3. The resin sealing plate 3 is placed on the substrate 2, with the back surface of thereof supported on the frames 6. Therefore, the spacing between the substrate 2 and the resin sealing plate 3 is determined by the height of the spacers 6.

The structure, in which the resin sealing plate 3 is attached to the substrate as supported on the frames 6, as described above, is used as a substrate structure for resin sealing. As a result, it is made possible to not only control the flow of the sealing resin 5 but also increase the rigidity of the structure, thereby making the structure easy to handle. In the case where the functional elements 1 are arrayed in a matrix form on the substrate 2 and the resin sealing plate 3 of a large size is formed therein with openings 3 in a matrix form, there is a possibility of the structure being made difficult to handle due to the lack in strength of the substrate 2 or resin sealing plate 3. In this case, by attaching the resin sealing plate 3 onto the substrate as supported on the frames 6, the substrate and resin sealing plate are reinforced with each other to increase the rigidity of the entire structure, thereby enabling the entire structure to be handled as a single hard substrate.

The fundamental structure to be adopted is a structure in which the frames 6 are disposed on the opposite sides of the functional element 1 and in which the sealing resin 5 is supplied from one of open ends of the functional element to be impregnated toward the other open end thereof When the functional elements 1 are arrayed in a matrix form, for example, the frames 6 are disposed between the adjacent functional elements 1. As a result, the frames 6 are disposed on the opposite sides of each functional element 1. It is here conceivable that the frames 6 are disposed on three sides of the functional element and that the sealing resin 5 is supplied from one open end of the functional element. In this case, however, there is concern that air bubbles remain in the spacing surrounded by the frames 6 because the air has its escape cut off.

Insofar as even a way of air escape can be secured, however, the positions of the frames 6 are not limited to only the opposite sides of the functional element 1. Even when the frames 6 are disposed on the three sides of the functional element, for example, formation of holes in the resin sealing plate 3 for escaping the air enables the impregnation and filling of the resin without allowing air bubbles to remain. Therefore, it is made possible to cause the frames 6 to surround each functional element 1 in a larger area than the size of a functional element-mounted module to be finally produced by the dicing treatment and to form a deflation hole at a position departing from the functional element-mounted module. When the frames 6 surround the functional element 1, as described above, it is also necessary to form a resin-supplying hole for dropping the sealing resin 5. In this case, therefore, a resin sealing plate 3 provided on one side of the opening 3a corresponding in position to the functional portion 1a of the functional element 1 with the resin-supplying hole and on the other side thereof with the deflation hole is used.

Next, the process of forming the frames 6 and sealing with the resin will be described. The procedure of sealing with the resin is the same as that in the preceding embodiment and utilizes the capillary phenomenon to impregnate and fill the sealing resin 5. Here, the structure of mounting the functional element 1 onto the substrate 2 will be described and then a method for producing a functional element-mounted module in consequence of the impregnation and filling of the sealing resin 5 will be described.

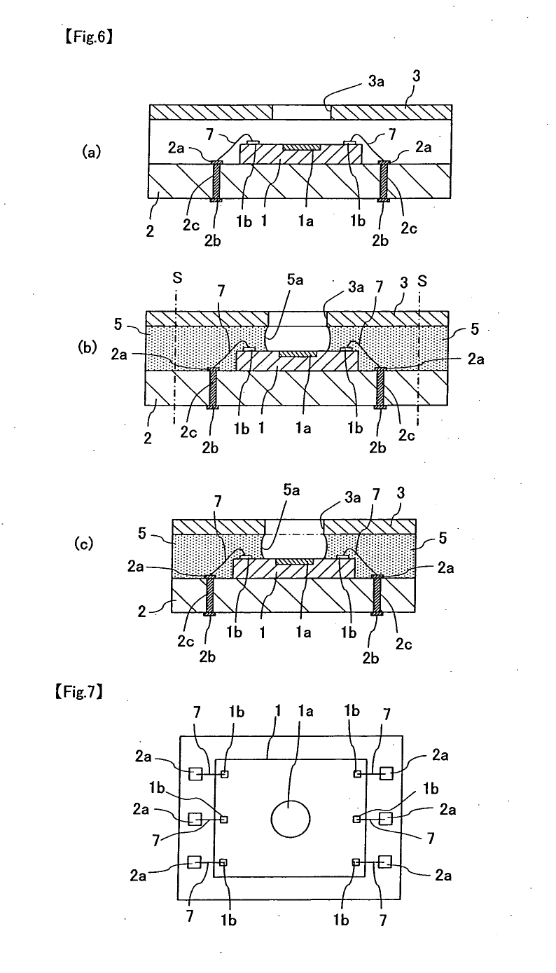

As shown in FIG. 6(a), in the present embodiment, the functional element 1 is fixed onto the substrate 2, and an electrode 1b of the functional element 1 and an electrode 2a of the substrate are bonded to each other with a wire 7 for electrical connection therebetween. In addition, the electrode 2a of the substrate 2 is connected with a via conductor 2c to an electrode provided on the backside of substrate for external connection. Therefore, the electrode 2b for external connection is connected to an external circuit to incorporate the functional element 1 into the external circuit. The planar arrangement of the electrodes 1b of the functional element and the electrodes 2a of the substrate 23 is as shown in FIG. 7.

Incidentally, since the wire 7 is generally drawn out to a position higher than the height of the functional element 1, it is required that the height of the frame 6 is set to be higher than the height of the wire 7 so that the resin sealing plate 3 may not come into contact with the wire 7.

The process of filling the sealing resin 5 is the same as in the preceding embodiment and utilizes the capillary phenomenon to impregnate and fill between the substrate 2 and the resin sealing plate 3 the liquid sealing resin 5 supplied onto the substrate 2. Here, the sealing resin 5 is regulated in its flow in one direction by means of the function of the frames 6 and gradually impregnated from one end to the other end of the functional element 1 to realize smooth impregnation and filling thereof. The state of the sealing resin 5 having been filled is shown in FIG. 6(b). The opening 5a is formed in the sealing resin 5 correspondingly in position to the opening 3a formed in the resin sealing plate 3 and the functional portion 1a of the functional element 1 faces the opening 5a. These states are the same as in the preceding embodiment.

The sealing resin 5 thus filled is cured through heating, for example, and the dicing (cutting) treatment is carried out to obtain individual functional element-mounted modules. The dicing treatment is carried out along scribe lines (shown by S-S lines). As a result, the functional element-mounted modules divided to have a prescribed chip size can be obtained. One functional element-mounted module divided is shown in FIG. 6(c).

The functional element-mounted module thus fabricated can secure its long-term reliability because the sealing resin 5 covers (is molded to) the electrodes 1b of the functional element 1 and the electrodes 2a of the substrate 2 to protect these electrodes form the external environment. The electrodes 1b and 2a are formed in the shape of aluminum pads, for example, and possibly corroded upon contacting the air etc. In the present embodiment, however, since these electrodes are sealed with the sealing resin 5, they will not be deteriorated by means of corrosion etc. On the other hand, since the functional portion 1a of the functional element 1 faces, as exposed to, the opening 5a of the sealing resin 5 and the opening 3a of the resin sealing plate 3, on the functional element 1a there is nothing to prevent the optical transmission, for example.

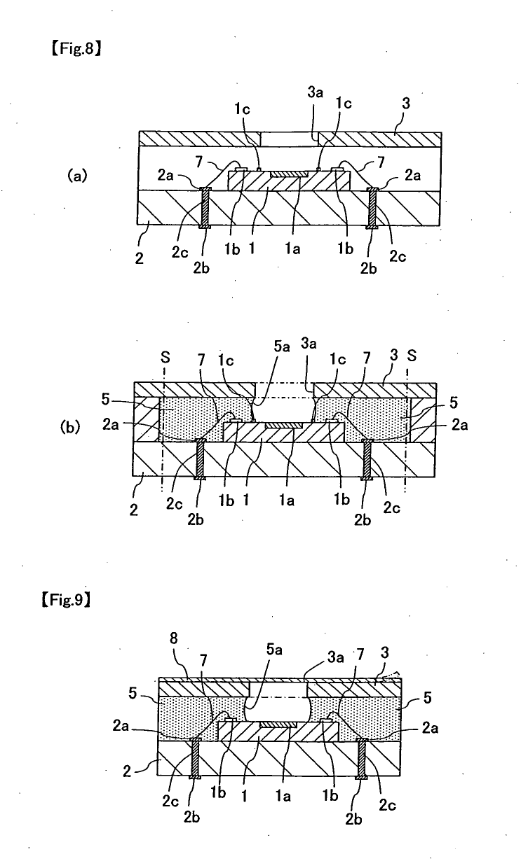

In the impregnation and filling of the sealing resin 5, a structure may be adopted, for example, in which small convexes 1c are formed around the functional portion 1a of the functional element 1 as shown in FIG. 8(a) to infallibly prevent the sealing resin 5 from invasion into the opening 3a (onto the functional element 1a). Though a process for forming the small convexes 1c is not limited, a preferable process is a photolithographic process using a material (polyimide, for example) for use in the formation of a protective film (passivation film) for the functional element 1 from the standpoint of diverting the existing semiconductor process.

The formation of the small convexes 1c around the functional portion 1a in the shape of a ring enables the sealing resin 5 to be infallibly prevented from invasion on the side of the functional element 1. Incidentally, the shape of the small convexes 1c may be determined in compliance with the shape of the functional portion 1a and is not limited to a circular ring but may be a square ring, a rectangular ring, etc. The state of sealing with the resin in the case of the formation of the small convexes 1c is shown in FIG. 8(b). The sealing resin 5 is blocked off by the action of the edge of the opening 3a on the side of the resin sealing plate 3 and by means of the small convexes 1c on the side of the functional element 1.

In addition, in place of the formation of the small convexes 1c, a groove surrounding the functional portion 1a may be formed on the passivation film to use it as a stopper for the sealing resin 5 similarly to the function of the small convexes 1c.

In the functional element-mounted module fabricated by the producing process described above, the functional portion 1a of the functional element 1 is exposed without being protected at all. As shown in FIG. 9, therefore, a protective film 8 may be attached to the resin sealing plate 3 for the purpose of protecting the opening 3a thereof. The attachment of the protective film 8 enables preventing extraneous matter to be attached onto the functional portion 1a during the storage of the functional element-mounted module, for example. In addition, when an exfoliatable film is used as the protective film 8 to exfoliate the film when using the functional element-mounted module, there is no obstacle to input light into or output light from the functional portion 1a.

Incidentally, when performing a reflow for the purpose of mounting the functional element-mounted module on another substrate in the state wherein the protective film 8 has been attached to the resin sealing plate 3 to stop up the opening 3a thereof, there is a possibility of the air in the spacing above the functional portion 1a being expanded. In view of this possibility, it is preferred that the surface of the resin sealing plate 3 onto which the protective film is to be attached is provided thereon with a groove as a gas discharge port 9. The formation of the gas discharge port 9 enables the air (gas) expanded in the opening to be rapidly discharged out when performing the reflow. In addition, the gas discharge port 9 serves also as a function to prevent dew condensation within the spacing.

When performing the impregnation and filling of the sealing resin, with the frames 6 formed on the opposite sides of the functional element 1, as described above, the flow of the sealing resin is regulated in one direction as shown in FIG. 11(a). The sealing resin 5 flowing so as to avoid the opening 3a of the resin sealing plate 3, however, fails to sufficiently circulate around the backside (downstream side) of the opening 3a to possibly induce insufficient sealing of the functional element 1 with the resin at this position. In order to eliminate such an inconvenience, it is effective to provide a resin flow control mechanism 10 for stemming part of the flow of the resin on the downstream side of the opening 3a to control the resin flow path.

As shown in FIG. 11(b), for example, provision of the resin flow control mechanism 10 for controlling the flow of the resin in such a manner as to narrow the resin flow path from the opposite sides enables the sealing resin 5 to flow inward on the downstream side of the opening 3a. As a consequence, the sealing resin circulates around the downstream side of the opening 3a in a sufficient amount to attain sufficient sealing of that portion with the resin.

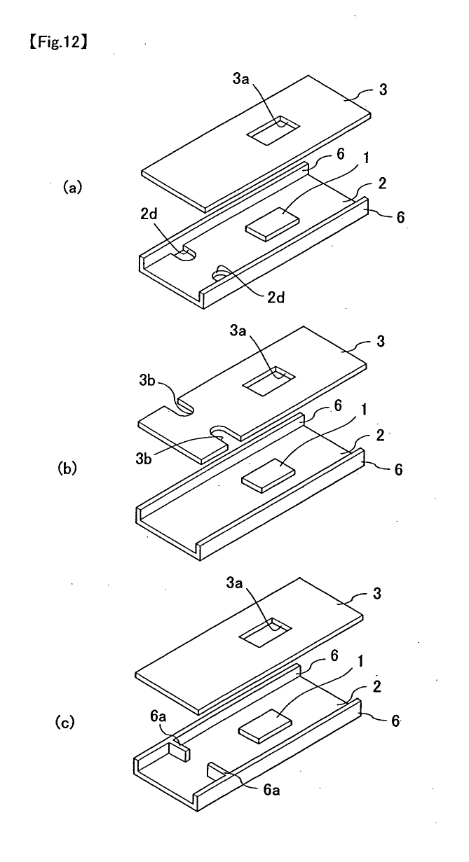

The resin flow control mechanisms 10 may be formed as shown in FIG. 12(a), for example, in the form of openings 2d bored in the substrate 2. The openings 2d have a function to prevent the flow of the sealing resin 5 by means of the surface tension similarly to the opening 3a formed in the resin sealing plate 3 and serve as the resin flow control mechanism. Otherwise, as shown in FIG. 12(b), it is possible to bore resin flow control openings 3b in the resin sealing plate 3 in addition to the opening 3a. In the case where an opening for supplying the sealing resin 5 is formed in the resin sealing plate, the resin flow control opening 3b and the sealing resin supplying opening are disposed across each opening 3a. The resin flow control opening 3b also functions to prevent the flow of the liquid sealing resin 5 utilizing the surface tension, similarly to the opening 3a or the opening 2d of the substrate. Furthermore, the frame 6 may be provided with projections 6a for preventing the flow of the sealing resin 5 to control the flow of the resin.

The embodiments of the present invention have been described in the foregoing. It goes without saying that the present invention is not limited to these embodiments. Various modifications can be given to the shapes and dimensions of the constituent elements, for example.

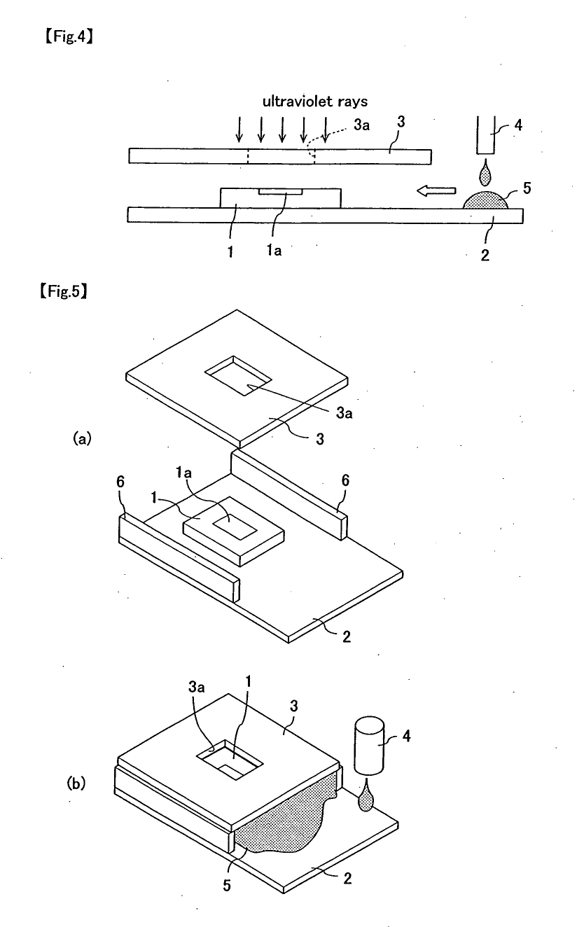

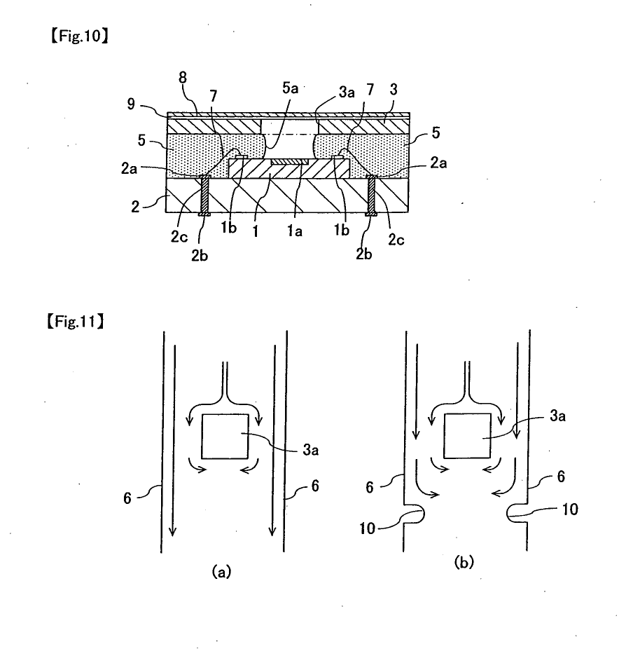

### BRIEF DESCRIPTION OF THE DRAWINGS

[FIG. 1] It is a schematic view showing the state of disposition of a substrate and a resin sealing plate, (a) being a side view thereof and (b) being a plan view thereof.

[FIG. 2] It shows examples of the shape of an opening formed in the resin sealing plate, (a) being a rectangular opening having rounded corners, (b) being a circular opening and (c) being an elliptical opening.

[FIG. 3] It is a schematic view showing a sealing resin being impregnated and filled, (a) showing a step of dropping the sealing resin and (b) showing a step of impregnating and filling the sealing resin.

[FIG. 4] It is a schematic view showing irradiation of ultraviolet rays.

[FIG. 5] It shows an example in which a functional element is provided on the opposite sides thereof with frame portions, (a) being an exploded perspective view thereof and (b) being a schematic perspective view showing the state of assemblage.

[FIG. 6] It shows the resin sealing process, (a) being a schematic cross section showing a functional-element-mounted structure and the state of disposition of the resin sealing plate, (b) being a schematic cross section showing the state of the sealing resin being filled and (c) being a schematic cross section showing a functional-element-mounted module after a dicing step.

[FIG. 7] It is a schematic plan view showing the functional-element-mounted structure.

[FIG. 8] It shows the manner of the sealing resin being impregnated and filled when small convexes have been formed around the functional portion, (a) being a schematic cross section assuming the state before the sealing is impregnated and filled and (b) a schematic cross section assuming the state wherein the sealing resin has been sealed.

[FIG. 9] It is a schematic cross section showing the state in which a protective film has been attached to the surface of the resin sealing plate.

[FIG. 10] It is a schematic cross section showing the state in which a gas discharge port has been formed.

[FIG. 11] It is a schematic explanatory view showing the flow of the sealing resin, (a) showing the flow of the resin regulated to one direction in the presence of the frame portions and (b) showing the flow of the resin, with the flow path narrowed by means of resin flow control mechanisms.

[FIG. 12] It is a schematic perspective view showing concrete examples of the resin flow control mechanisms, (a) showing the mechanisms in the form of openings formed in the substrate, (b) showing the mechanisms in the form of openings formed in the resin sealing plate and (c) showing the mechanisms in the form of projections formed on the frame portions.

[FIG. 13] It is a schematic cross section showing one example of a prior art structure having a functional element sealed with resin.

### EXPLANATION OF REFERENCE NUMERALS

1 a functional element, 1a a functional portion, 2 a substrate, 2a electrodes, 2b electrodes for external connection, 2c via conductors, 2d openings, 3 a resin sealing plate, 3a an opening, 3b resin flow control openings, 4 a dispenser, 5 a sealing resin, 6 frame portions, 6b projections, 7 wires, 8 a protective film, 9 a gas discharge port, and 10 resin flow control mechanisms.

1. A functional-element-mounted module comprising:
a substrate;
a functional element provided with a functional portion and mounted on the substrate;
a resin sealing plate formed therein with an opening corresponding in position to the functional portion of the functional element and disposed as opposed to the substrate at a distance of 200 μm to 1000 μm; and
a sealing resin impregnated and filled between the substrate and the resin sealing plate and formed therein with an opening corresponding in position to the opening of the resin sealing plate;
wherein the functional portion of the functional element faces the opening of the sealing resin.

2. A functional-element-mounted module according to claim 1, wherein the functional element has a surface separated from the resin sealing plate by a distance of 100 μm to 600 μm.

3. A functional-element-mounted module according to claim 1, wherein the opening of the resin sealing plate has a substantially rectangular shape having corners made arcuate.

4. A functional-element-mounted module according to claim 1, wherein the opening of the resin sealing plate has a circular or elliptical shape.

5. A process for producing a functional-element-mounted module, comprising the steps of:
disposing a substrate having mounted thereon a functional element having a mounting portion and a resin sealing plate formed therein with an opening corresponding in position to the functional portion of the functional element as opposed to each other at a predetermined distance; and
impregnating and filling a sealing resin between the substrate and the resin sealing plate utilizing a capillary phenomenon.

6. A process for producing a functional-element-mounted module according to claim 5, wherein the predetermined distance is 1000 μm or less.

7. A process for producing a functional-element-mounted module according to claim 5, wherein the sealing resin is a liquid resin and further comprising the steps of forming frame portions on opposite sides of the functional element for controlling flow of the liquid resin and supplying the liquid resin from one of opposed open ends of an spacing defined by the frame portions.

8. A process for producing a functional-element-mounted module according to claim 7, further comprising the step of forming at the other of the opposed open ends a resin flow control mechanism functioning to narrow a flow path for the liquid resin.

9. A process for producing a functional-element-mounted module according to claim 8, wherein the resin flow control mechanism comprises resin flow control openings formed in the resin sealing plate or substrate.

10. A process for producing a functional-element-mounted module according to claim 5, wherein the sealing resin when being impregnated and filled has a viscosity of 10 Pa·s.

11. A process for producing a functional-element-mounted module according to claim 5, further comprising the step of thermally curing the sealing resin having been impregnated and filled.

12. A process for producing a functional-element-mounted module according to claim 5, wherein the sealing resin is a ultraviolet-curable resin and the step of impregnating and filing the sealing resin is performed while irradiating a neighborhood of the opening of the resin sealing plate with ultraviolet rays.

13. A process for producing a functional-element-mounted module according to claim 5, further comprising the step of bonding a protective film onto the resin sealing plate when the sealing resin has been cured, thereby covering the opening of the resin sealing plate.

14. A process for producing a functional-element-mounted module according to claim 5, further comprising the step of forming convexes to surround the functional portion of the functional element before the step of impregnating and filling the sealing resin.

15. A resin sealing plate used in the process for producing a functional-element-mounted module according to claim 5, said resin sealing plate having the opening corresponding in position to the functional portion of the functional element and resin flow control openings for controlling flow of the sealing resin utilizing surface tension.

16. A resin sealing plate according to claim 15, wherein the opening corresponding in position to the functional portion of the functional element has a substantially rectangular shape having corners made arcuate.

17. A resin sealing plate according to claim 15, wherein the opening corresponding in position to the functional portion of the functional element is arranged in a matrix form, and the resin flow control openings is paired to narrow a flow path for the sealing resin from opposite sides thereof.

18. A resin sealing plate according to claim 15, wherein the resin sealing plate has an opening for supplying the sealing resin at a position opposed to the resin flow control openings and across the opening corresponding in position to the functional portion of the functional element.

19. A substrate structure for resin sealing, comprising:
a substrate;
a functional element provided with a functional portion and mounted on the substrate;
a resin sealing plate formed therein with an opening corresponding in position to the functional portion of the functional element and disposed as opposed to the substrate at a predetermined interval; and
projecting frame portions formed on the substrate at opposite sides of the functional element for supporting the resin sealing plate thereon so as to be disposed as opposed to the substrate at the predetermined interval.

20. A substrate structure for resin sealing according to claim 19, further comprising resin flow control openings formed in the substrate for functioning to narrow a flow path for a sealing resin.

21. A substrate structure for resin sealing according to claim 19, wherein the resin sealing plate is the one according to claim 15.
